(19) United States
(12) Patent Application Publication
(10) Pub. No.: US 2013/0193080 A1
(43) Pub. Date: Aug. 1, 2013

(54) METHOD FOR MANAGING THE REVERSAL FREQUENCY OF AN ELECTROCHEMICAL REACTOR

(71) Applicants: Philippe Grard, Mauguio (FR); Patrice Coquelle, Sainte Croix de Quintillargues (FR)

(72) Inventors: Philippe Grard, Mauguio (FR); Patrice Coquelle, Sainte Croix de Quintillargues (FR)

(73) Assignee: POOL TECHNOLOGIE, Valergues (FR)

(21) Appl. No.: 13/876,371

(22) PCT Filed: Sep. 27, 2011
(86) PCT No.: PCT/FR11/52258

§ 371 Date: Apr. 3, 2013

(30) Foreign Application Priority Data
Sep. 27, 2010 (FR) 1057748

(51) Int. Cl. C02F 1/467

(52) U.S. Cl. CPC C02F 1/4672
USPC 210/743

(57) ABSTRACT

The method for managing the polarity-reversal frequency of at least one pair of electrodes in an electrochemical reactor for water electrolysis includes observing a fluctuation in the hydrogen potential (pH) of the water, while carrying out a comparison of the pH measured at a given moment with a previous measurement or a predetermined initial value. An amount of treatment agent is injected into the water to adjust the pH to around a defined set point. The polarity-reversal frequency of electrodes is calculated on the basis of the temperature of the water, the pH fluctuation and amount of agent injected. The method includes estimating the total alkali strength on the basis of the injected amount and the pH fluctuation, anticipating the fluctuations in the pH relative to the preceding estimations, and readjusting complete alkalinity titration estimate and calculation of the polarity-reversal frequency.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

The present invention is related to the field of processing of the water of pools, water bodies, swimming-pools, spas and tanks, in particular processing of water through electrolysis.

In the meaning of the present application, by <<electrolysis>> is understood any kind of electrochemical reaction consisting in transforming electric energy into a chemical reaction, namely referred to as electrolysis or hydrolysis.

The invention will find a particular, but in no way restrictive, application in the processing of pool- and swimming-pool water at individuals' and collectives' places. The invention can be contemplated, one the one hand, for processing drinking water and, on the other hand, in the fields of fish farming or agriculture.

2. Description of Related Art Including Information Disclosed under 37 CFR 1.97 and 37 CFR 1.98

As is well known, pool- and swimming-pool water possesses a potential of hydrogen (pH) that tends to vary in time for multiple reasons, such as the heating of the water, the natural stirring of the water, the natural evaporation of carbon dioxide or the addition of disinfecting products.

In the latter case, an alternative solution for the addition of disinfecting products, which are expensive and dangerous to be handled, consists in proceeding to the electrolysis of the water, so as to directly create a disinfectant from the water present in the pool.

The electrolysis consists in breaking a molecule by generating a current between two electrodes made out of a conductive material, such as titan.

On the one hand, water electrolysis separates the water molecule (H₂O) in order to obtain ions, hydroxyl radicals or such as hydrogen peroxide, which possess a high oxidizing power. An example of use of water electrolysis is described in FR 2 784 979.

On the other hand, the addition of an additive permits an electrolysis that then consists in separating the molecules present in the water and in thus creating a disinfectant. In the present case, hypochlorous acid is obtained from sodium chloride.

Either of these techniques requires however a precise pH in order to optimize the chemical reaction, so that this parameter has to be checked periodically, in order to increase it, to maintain it or to decrease it by injection of an adapted product, namely doses of acid.

These electrolytic actions produce a drawback related to the fouling of the electrodes of the electrochemical reactor during their use, due to a deposition of chalk and scale, in particular so-called <<incrusting>> or <<semi-incrusting>> scale, as well as the so-called <<soft>> scale.

Such a deposition occurs at the level of the cathode, which, because of its negative polarity, is more basic than the anode. Therefore, this deposition reduces the conductivity of the electrochemical reactor, namely by reducing the conductivity of the electrolyte. In addition, the deposited layer results in that the dihydrogen (H₂) can no longer be released, thus eroding the coating of the cathode, which will progressively no longer assume its role in the reaction.

If the deposition on the cathode reaches the anode, a higher production of oxygen will occur to the detriment of the chlorine, damaging said anode and causing a premature deterioration of the electrochemical reactor.

Once they are fouled, the electrodes lose their efficiency. They must therefore be cleaned periodically.

A first solution, generally used in the industry, consists in doubling the electrochemical reactor and in alternating their operation. Therefore, when one reactor is used, the other one can be cleaned, and vice-versa. Such a cleaning occurs manually by means of an acid, is therefore constraining and gives rise to a manipulation of hazardous products. In addition, it requires a non-negligible additional investment, of course acceptable for a collectivity, but too expensive for individuals.

Another more advanced solution consists in periodically reversing the polarity of the electrodes. A method for reversing the polarity of the electrodes is described namely in WO 2006/058369.

In addition, the reversal periods, formerly fixed at a given frequency, are sometimes foreseen adjustable depending on several parameters. Indeed, the quantity and the speed of this deposition depend: on the temperature of the water, its pH, the duration of the electrolysis combined with the surface of the electrodes, the intensity of the current, the hardness of the water (i.e. the hydrotimetric titration (TH) indicating the degree of mineralization of the water).

More specifically, waters can be qualified as <<soft>> or <<hard>> depending on the concentrations of the elements they contain, in particular of the positive ions, such as the calcium (Ca²⁺), magnesium (Mg²⁺) cations and the hydronium (H₃O*) ions, as well as of the negative ions, such as the bicarbonate (HCO₃⁻), carbonate (CO₃²⁻) and hydroxide (OH⁻) anions.

Waters are considered soft when they contain few calcium or magnesium salts, and inversely, waters are hard when these quantities are high. Logically, one can deduce therefrom that soft waters, little loaded with salts, have a high potential of dissolution of the materials they are in contact with, while the hard waters, rich in salts, let the less soluble of them precipitate, then forming depositions. The latter occur depending on the balance pH of the water or so-called <<saturation pH>>, beyond which forms a precipitation of the calcium and bicarbonate ions. Therefore, water the pH of which is higher than the balance pH is considered as incrusting (in contrast, it will be considered as <<aggressive>>) and generates a deposition.

Therefore, the main parameter taken into consideration is the hardness of the water. Indeed, depending on the TH of the water, the periods of polarity reversal of the electrodes are then determined.

However, the periodical polarity reversal of the electrodes considerably reduces their lifetime, requiring to more frequently replace the electrochemical reactor.

An exemplary polarity reversal of the electrodes of an electrolytic cell is described in FR 2 704 872. This device for producing sodium hypochlorite foresees a periodic reversal depending on the hydrometric titration (TH) or <<hardness>> of the water, by increasing the duration of the reversals the higher the TH is.

In addition, such a device foresees to maintain the pH of the medium by detecting its value and by injecting acid by means of a metering pump. In particular, this injection can be carried out depending on the threshold temperature, lower than 3° C. (degrees Celsius), in order to maintain the medium out of freezing condition.

However, such a device pretends to be capable of maintaining the production of hypochlorite constant and contemplates the cleaning of the electrodes in order to preserve this maintaining, without therefore ensuring the optimizing of the lifetime of said electrodes.

A solution has been brought by US 2001/0004962, which describes a device for treating water by electrolysis. In particular, it foresees to control the polarity-reversal frequency of the electrodes depending on the hardness of the water (TH).

It is already observed that none of the existing solutions use the quantity of treatment agent, namely acid, and the fluctuation of the pH resulting from this injected quantity for calculating the reversal frequency of the electrodes. However, as a matter of fact the quantity of agent injected and the modification of the pH will considerably change the hardness (TH) of the water.

### SUMMARY OF THE INVENTION

The invention is aimed at coping with the drawbacks of the state of the art by providing to intelligently control of the polarity reversal of the electrodes depending on the temperature and the pH of the water.

Advantageously, the calculation of the reversal occurs depending on the quantity of treatment agent injected and on the fluctuation of the pH.

In addition, the invention uses the complete alkalinity titration (CAT), i.e. the magnitude used to measure the rate of hydroxides, carbonates and bicarbonates of a water. The CAT is a datum completely different from the hydrometric titration (TH or hardness of the water)

Therefore, these combined parameters permit to obtain a corrosivity index of the water, indicating the scaling speed of the electrochemical reactor. The more the water is incrusting, the earlier will occur the scaling.

Contrarily to the pH and the temperature, which are easily measurable, since the CAT is unknown, the invention pretends to estimate it, in particular through the quantity of treatment agent, namely acid, added to the water to keep its pH at a stable value.

Indeed, by titrating the water with an acid, it is possible to obtain an exact estimation of the CAT. The acids are ion donors (H⁺) that combine with the hydrogen carbonates (CHO₃⁻) to form carbonic acid gas and water. The carbon dioxide, dissolved in saturation in water, desorbs and re-establishes the balance with the carbonic acid gas present in the air. This phenomenon of buffering of the water reduces the action of an acid on the water, with respect to its bicarbonate titrations.

Moreover, the addition of a strong acid to regulate the pH reduces the quantity of hydrogen-carbonate anions and hence the CAT. The continuous regulation of the pH thus results into the progressive de-carbonation of the water. Then, once all the hydrogen-carbonate anions have been suppressed (i.e. the CAT has lowered to a value equal to zero), no chalky buildup is possible anymore and the addition of a strong acid to the water produces important variations on the pH, causing its instability.

Therefore, the water becomes aggressive, causing for example a risk of attacking any metallic part in contact with the water (such as the ladder, the filtering pump fittings, . . . ) as well as the coatings (such as the seams of the tiling or the liner of a swimming-pool). That is why it is necessary to maintain a minimum CAT, in order to avoid producing the instability of the pH and making the water too aggressive.

The invention pretends to be able to provide a prediction of the CAT, in order to avoid making the water aggressive.

The invention thus results from the combination of the fields of water chemistry, from the quantizing of its pH and from the deduction of its CAT as well as from the management of the latter, in order to adjust, through increasing or reducing, the polarity-reversal frequency of the electrodes.

Therefore, the invention permits to limit the buildup of chalk and scale between the electrodes of said electrochemical reactor and thus to extend by several years the lifetime of the electrochemical reactor.

In addition, all the operations occur automatically, in a transparent way for the user.

The invention provides in addition a stability of the pH over time, serving as a reference for an exact calculation of the quantities of treatment agent to be injected in order to maintain this same pH at a constant value.

To this end, the present invention relates to a method for managing the polarity-reversal frequency of at least one pair of electrodes within an electrochemical reactor for electrolyzing the water, wherein:

at least a fluctuation in the hydrogen potential (pH) of the water is observed, while carrying out a comparison between the pH measured at a given moment with respect to a previous measurement or a determined initial value;

an amount of treatment agent, in the form of a base or an acid, is injected into the water, depending on said fluctuation observed of the pH, in order to regulate the pH around a defined set point;

the polarity-reversal frequency of said electrodes is calculated depending on the temperature of the water, on said pH fluctuation and on said quantity of treatment agent injected;

characterized in that it consists in:

estimating the complete alkalinity titration (CAT) depending on said quantity injected and on said pH fluctuation, in order to maintain the CAT at a minimum level; and

anticipating the pH fluctuations with respect to the preceding estimations of the volume of treatment agent to be injected to stabilize said pH at a set point, and readjusting the estimation of the CAT and the calculation of said polarity-reversal frequency.

Further features and advantages of the invention will become clear from the following detailed description of the non-restrictive embodiments of the invention.

### BRIEF DESCRIPTION OF THE DRAWINGS

None.

### DETAILED DESCRIPTION OF THE DRAWINGS

The present invention relates to the treatment of the water of a pool, water body, swimming-pool, spa, tank or the like, through an electrochemical reaction by means of an electrochemical reactor.

The invention is related in particular to the maintenance and the cleaning of an electrochemical reactor, in order to avoid the deposition of chalk and scale, through polarity reversal of at least one pair of electrodes contained in said electrochemical reactor.

To this end, the object of the present invention is a method for managing the polarity-reversal frequency of at least one pair of electrodes within an electrochemical reactor.

Each polarity reversal of a couple of electrodes is thus controlled periodically. Between two reversals, a current is generated so as to flow from the cathode to the anode. At the end of a period, the reversal thus consists in changing the direction of the current, the cathode becoming the anode, and vice-versa.

Advantageously, in a first phase, the method according to the invention consists in observing a fluctuation of the hydrogen potential (pH) of the water.

In particular, this observation of a variation of the pH can occur continuously or at regular intervals. In addition, the values of the measurements carried out can be recorded, so as to perform a calculation, namely an average value.

Similarly, the temperature of the water can also be measured, continuously or at regular intervals, whereby the values obtained can be saved in order to serve as parameter in a subsequent calculation.

It should be noted that said fluctuation consists in carrying out a comparison between the pH measured at a given moment with respect to a previous measurement or a determined initial value. The latter depends at least on the volume of water contained in the pool or tank as well as on the technical characteristics of the pump for injecting the treatment agent.

In this respect, depending on the fluctuation of the pH, a quantity of treatment agent is injected into the water so as to stabilize said pH, by increasing it, by maintaining it or by decreasing it. This stabilization namely permits to preserve the adequate conditions for carrying out the electrolysis.

It should be noted that such a treatment agent can be an acid, but also a base. In the case of an acid, said agent can be in the form of hydrochloric acid (HCl) or sulfuric acid (H₂SO₄), reciprocally at concentrations in the range from 10 to 30% or from 30 to 50%.

Therefore, the method according to the invention can integrate a taking into consideration of the concentration of the treatment agent, manually through a selection made by a user determined depending on the product (for example 25% for the injection of hydrochloric acid). The invention permits to adapt to the quantity of treatment agent injected, irrespective of its concentration.

To this end, the invention also takes into consideration the flow rate of the pump for injecting said treatment agent and the injection time, in order to determine the quantity injected.

The volume of water of the pool or tank to be treated is also taken into consideration, in order to interpret the fluctuations of the pH.

Advantageously, an essential feature of the invention consists in calculating the polarity-reversal frequency of at least one pair of electrodes of said electrochemical reactor depending on said pH and on said quantity of treatment agent injected, these two parameters being related to each other.

Once this frequency has been determined, it is then possible to determine the optimal duration of the period between two successive polarity reversals.

The larger the quantity of injected agent is, the shorter will be the reversal periods. In brief, the more the water is mineralized, the closer in time will be the polarity reversals.

According to another feature, the method according to the invention consists in determining the complete alkalinity titration (CAT) of the water and in calculating the reversal frequency depending on said CAT.

In particular, the invention consists in estimating the CAT depending on said quantity of treatment agent injected. This estimation can occur continuously or periodically, so as to adjust continuously or periodically the reversal frequency.

This estimation of the CAT is preferably obtained depending on the pH fluctuation. It can also be obtained and determined exactly from the temperature of the water.

As regards the temperature, as evoked above, calcium carbonate is very little soluble in pure water, but soluble to a higher extent in water loaded with dissolved carbonic acid gas. Moreover, the solubility of the gases in the water decreases when the temperature increases, the temperature of the water thus modifies the solubility of the calcium carbonate, which rather tends to form a deposition in hot waters.

Within the framework of an application for swimming-pools, the electrolysis is generally performed between a precise range of temperatures, for example between 15 and 35 degrees Celsius. Outside this interval, the electrolysis action can be stopped, saving the lifetime of the electrochemical reactor.

In particular, the invention provides to use a compensation that permits to cause the calculation of the polarity-reversal period only when the temperature has an effect on the carbonation. This compensation occurs thus only when the temperature varies beyond a difference of more or less 20 to 50% around a previously measured temperature.

Furthermore, the invention also provides to take into consideration the current density in Amperes per square decimeter between the couple of electrodes within the electrochemical reactor. Similarly, a coefficient permits to adjust the theoretical density, for example 3 A/dm².

According to another feature, a set point is defined so as to regulate the pH around this reference value. This set point is taken into consideration to ensure a compensation in the calculation of the reversal time. Indeed, the solubility of the calcium carbonate depends on the carbon dioxide titration that is inversely proportional to the hydrogen carbonate titration.

This set point has been fixed around the saturation pH, i.e. between a measured pH between 7 and 8.3. Indeed, at a pH of 8.3, the hydrogen carbonate titration is maximum. Therefore, a 20% increase of this titration to a pH between 7 and 8.3 will result into a 20% compensation of the reversal time calculated.

It should be noted that the invention can foresee not to modify the reversal period for a measured pH lower than 7. Indeed, it is then not necessary to extend the reversal time below this value, because a lowering of the pH would necessarily result from a factor external to the parameters taken into consideration by the invention, namely a manual addition of a dose of treatment agent.

Moreover, below this pH equal to 7, no risk is detected for the electrochemical reactor, the risks of deposition being minimal.

According to an additional feature, the invention provides a predictive aspect, i.e. it anticipates the pH fluctuations with respect to the preceding estimations of the volume of treatment agent to be injected to stabilize the pH at the set point, and hence to re-adjust the estimation of the CAT and finally the calculation of the optimal time of the polarity-reversal frequency.

In particular, the last three injections and estimations can be stored and taken into consideration.

According to an additional feature, the invention permits, once the CAT has been estimated, to define thresholds beyond which the water becomes corrosive or scaling. Therefore, an alarm can be triggered to inform the user, who can intervene manually and quicker. Depending on the cases, the user can take the necessary measures at larger scale, namely through a massive renewal of a quantity of water, or through monitoring the level of treatment agent and carrying out a refilling or through the addition of an adapted agent, namely such as sodium bicarbonate referred to as <<CAT⁺>>.

The invention thus consists in predicting the CAT by calculating the average values of the CATs estimated during the preceding injections.

Thus, the present invention permits to optimize the lifetime of each couple of electrodes by calculating, continuously or at regular intervals, the proper and optimal moment for reversing the direction of the current flowing through them, in particular before the forming of a first layer of scale on the cathode.

1. Method for managing polarity-reversal frequency of at least one pair of electrodes within an electrochemical reactor for electrolyzing the water, the method comprising the steps of:
observing at least a fluctuation in hydrogen potential (pH) of water, while carrying out a comparison between the pH measured at a given moment with respect to a previous measurement or a determined initial value;
injecting an amount of treatment agent, in the form of a base or an acid, into the water, depending on said fluctuation observed of the pH, in order to regulate the pH around a defined set point;
calculating polarity-reversal frequency of said electrodes depending on temperature of the water, on said pH fluctuation and on said quantity of treatment agent injected;
estimating complete alkalinity titration (CAT) depending on said quantity injected and on said pH fluctuation, in order to maintain the CAT at a minimum level; and
anticipating the pH fluctuations with respect to the preceding estimations of the volume of treatment agent to be injected to stabilize said pH at a set point, and readjusting the estimation of the CAT and the calculation of said polarity-reversal frequency.

2. Method for managing according to claim 1, wherein the step of observing the pH fluctuation is continuous or at regular intervals.

3. Method for managing according to claim 1, wherein said set point is defined as a reference value for a pH between 7 and 8.3.

4. Method for managing according to claim 1, the method further comprising the step of:
determining the quantity of treatment agent to be injected depending on its concentration, the flow rate of the injection pump and the injection time and the volume of water to be treated.

5. Method for managing according to claim 1, wherein the step of estimating the CAT is continuous or at regular intervals.

6. Method for managing according to claim 1, wherein the step of estimating the CAT depends on temperature of the water and the volume of water.

7. Method for managing according to claim 1, further comprising the step of:
predicting the CAT by calculating the average values of the CATs estimated during the preceding injections.
